(19) United States
(12) Patent Application Publication
(10) Pub. No.: US 2017/0293757 A1
(43) Pub. Date: Oct. 12, 2017

(54) Systems and Methods for Enhancing Control System Security by Detecting Anomalies in Descriptive Characteristics of Data

(71) Applicant: BRIGHTSOURCE ICS2 LTD., Jerusalem (IL)

(72) Inventors: Eyal ROSENMAN, Motsa Illit (IL); Gil KROYZER, Jerusalem (IL); Omri GREEN, Yehud-Monosson (IL)

(73) Assignee: Brightsource ICS2 Ltd., Jerusalem (IL)

(21) Appl. No.: 15/516,884

(22) PCT Filed: Oct. 6, 2015
(86) PCT No.: PCT/IB2015/057641

§ 371 Date: Apr. 4, 2017

Related U.S. Application Data
(60) Provisional application No. 62/060,442, filed on Oct. 6, 2014.

(51) Int. Cl. G06F 21/55; G06F 21/56; H04L 29/06

(52) U.S. Cl. CPC G06F 21/552; G06F 21/554; H04L 63/1433; G06F 21/563; H04L 63/1416; G06F 21/55; H04L 63/1408

(57) ABSTRACT

To enhance the security of an industrial control system, a data stream can be received from an input device via a communications network or an I/O subsystem of a computer system. All or part of the data stream can be stored in computer memory. Stored elements of the data stream can be retrieved from the memory. A set of program instructions can be executed to ascertain descriptive characteristics of the stored elements. Using a comparison with a stored normative descriptive characteristic in a database or application of an algorithm, heuristic or rule, it can be determined whether any of the descriptive characteristics are anomalous. When the existence of an anomalous descriptive characteristic has been determined, an alarm can be created, data or an alarm can be communicated to a control system or an operator, and/or the data or alarm can be recorded in a database.

### FIELD

The present disclosure generally relates to enhancing the security of industrial control systems and, more particularly, to methods and systems wherein computer processors can identify, detect and react to anomalous descriptive characteristics in data accessed through communication with input devices of the industrial control system.

### SUMMARY

The security of industrial control systems can be enhanced by identifying, detecting and reacting to data with anomalous descriptive characteristics when communicated by input devices connected to a system computer. The communicating can include communicating through a network. Descriptive characteristics describe data points and data values related to the design and operation of an industrial system, in terms that do not relate to the values themselves. Descriptive characteristics can be of individual data points accessed from input devices, and can be of pluralities of data points.

According to embodiments, a method is provided for enhancing the security of an industrial control system that includes at least one input device. The method, when carried out by one or more processors of a computer system, can include the process steps of (a) receiving or accessing, via a communications network, a data stream from an input device, and storing all or part of the data stream in memory that can be either volatile or non-volatile; (b) retrieving stored elements of the data stream, which can include a plurality of individual data points, from memory and ascertaining a plurality of descriptive characteristics of the data stream; (c) using at least one of comparison with a stored value in a database and application of an algorithm, heuristic or rule to determine whether any of the plurality of descriptive characteristics are anomalous; and (d) if and when the existence of an anomalous descriptive characteristic has been thus determined, performing a communication function selected from the group consisting of creating an alarm, communicating data or an alarm to at least one of a control system and an operator, and recording the data or the alarm in a database.

In some embodiments the plurality of descriptive characteristics can include a descriptive characteristic of an individual data point. A descriptive characteristic of an individual data point can be selected from the group consisting of data format, number format, data encoding characteristics, bit length, precision, rounding characteristics and rounding artifacts.

In some embodiments, the plurality of descriptive characteristics can include a descriptive characteristic of a plurality of data points. A descriptive characteristic of a plurality of data points can be selected from the group consisting of distributions of values, patterns of values, frequency of values, discretization parameters, discretization artifacts, report timing, reporting thresholds, reporting frequency and reporting periodicity. A plurality of data points can comprise sequential points in a data stream.

In some embodiments, the determining of whether any descriptive characteristics are anomalous can include testing descriptive characteristics using at least one of a rule, algorithm or heuristic. In some embodiments, the ‘failure’ to pass a test can cause the descriptive characteristic to be deemed anomalous, and in other embodiments the ‘failure’ to pass a test can trigger a ‘further determining’ step in which a determination is made as to whether the failed test causes the descriptive characteristic to be deemed anomalous. The ‘further determining’ can be carried out by using or applying a rule that is at least one of: stored in a computer-readable medium, and generated or derived by the one or more computer processors each time the further determining step is carried out, and can be carried out using an algorithm or a heuristic.

Alternatively or additionally, the determining whether any descriptive characteristics are anomalous can include comparing at least one of the descriptive characteristics to a normative descriptive characteristic or set of normative descriptive characteristics for the same input device or its functional equivalent, and further determining whether any deviation existing therebetween renders a respective descriptive characteristic anomalous. A normative descriptive characteristic can be one of an acceptable value for the respective descriptive characteristic, a range or set of values for the respective descriptive characteristic, and a value derived using a rule, algorithm or heuristic and deemed an appropriate value for the respective descriptive characteristic. Normative descriptive characteristics can be pre-determined and stored in a computer-readable medium and can comprise a fixed or temporary database. Pre-determined and stored normative descriptive characteristics can be used to create a ‘security signature’ that is pre-programmed into the input device for the purpose of enhancing the security of the industrial control system. Additionally or alternatively, normative descriptive characteristics can be generated or derived by the one or more computer processors each time a ‘comparing’ step is carried out. In embodiments, normative descriptive characteristics can be generated or derived by using or applying a rule that is at least one of: stored in a computer-readable medium, and generated or derived each time normative descriptive characteristics are generated or derived. Additionally or alternatively, normative descriptive characteristics can be machine-learned, or resultant from data mining, or derived using an algorithm or a heuristic.

In some embodiments, the existence of any deviation between a descriptive characteristic and a respective normative descriptive characteristic may directly trigger a program step that marks the descriptive characteristic as anomalous. In some embodiments, there can a further determining of whether a specific deviation constitutes an anomaly. The ‘further determining’ can be carried out by using or applying a rule that is at least one of: stored in a computer-readable medium, and generated or derived by the one or more computer processors each time the further determining step is carried out, and can be carried out using an algorithm or a heuristic.

In some embodiments, a non-transitory computer-readable medium can contain program instructions for enhancing the security of an industrial control system that includes at least one input device, wherein execution of the program instructions by one or more processors of a computer system causes the one or more processors to carry out the steps of: (a) accessing, via a communications network, a data stream from an input device; (b) analyzing the data stream and ascertaining a plurality of descriptive characteristics thereof; (c) determining whether any of the plurality of descriptive characteristics are anomalous; and (d) when the existence of an anomalous descriptive characteristic has been determined, performing a communication function selected from the group consisting of creating an alarm, communicating data or an alarm to at least one of a control system and an operator, and recording the data or the alarm in a database.

In embodiments, the non-transitory computer-readable medium can be characterized by the plurality of descriptive characteristics including a descriptive characteristic of an individual data point, the descriptive characteristic being selected from the group consisting of data format, number format, data encoding characteristics, bit length, precision, rounding characteristics, rounding artifacts. Additionally or alternatively, the non-transitory computer-readable medium can be characterized by the plurality of descriptive characteristics including a descriptive characteristic of a plurality of data points, the descriptive characteristic being selected from the group consisting of distributions of values, patterns of values, frequency of values, discretization parameters, discretization artifacts, report timing, reporting thresholds, reporting frequency and reporting periodicity.

In some embodiments, the non-transitory computer-readable medium can be characterized by the program instructions including at least one of a rule, an algorithm or a heuristic to be applied in carrying out the determining step. Additionally or alternatively, the non-transitory computer-readable medium can be characterized by the program instructions including at least one of a stored normative descriptive characteristic and a stored rule for determining whether a descriptive characteristic is anomalous.

### BRIEF DESCRIPTION OF THE DRAWINGS

Embodiments will hereinafter be described with reference to the accompanying drawings. Where applicable, some features may not be illustrated to assist in the illustration and description of underlying features. Throughout the figures, like reference numerals denote like elements.

FIG. 1A shows a flow chart of the process steps of a method in accordance with an embodiment of the invention.

FIGS. 1B, 2, 3 and 4 each show a flow chart of a process step in accordance with one or more embodiments.

FIG. 5 is a schematic diagram of a computer system and a plurality of communications networks in accordance with one or more embodiments.

### DETAILED DESCRIPTION

An industrial control system (ICS) such as for example a supervisory control and data acquisition system (SCADA) may include numerous data input devices. The input devices can send data to a supervisory computer system over a communications network. Input devices can be any source of data relevant to the supervision function such as sensors, the supervisory computer itself, a remote input terminal, a network, a virtual network, or data logs known libraries from databases.

In embodiments, data can include single input or output data points from processes or components monitored or controlled by the ICS. A data point's value can represent an actual input or output within the system, for example a measured or observed value, and can represent a calculated or derived value that results from logic and math operations applied to other data points. A data point's value can be the result of discretization or sampling of continuous inputs or outputs, and can be the result of conversion or mapping from one data format to another, including analog to digital, or digital to digital. Data can also include streams of data including multiple data points which may or may not be sequential.

Data transmitted over a communications network as a data stream comprising one or more data points is a digital representation of information that can be created in either digital or analog form. Where analog data is created, for example by a sensor, it can be necessary to convert analog waveforms into digital values. Both remote terminal units (RTUs) and programmable logic controllers (PLCs) are networked devices commonly used in industrial control systems, and either type of device can be used to connect to a sensor and convert sensor signals to digital data. Therefore, for the purposes of this disclosure, input devices can include RTUs and PLCs or any other devices used to sample or discretize analog signals.

Data points and their values can have descriptive characteristics. Descriptive characteristics describe data points and data values in terms that do not relate to the values themselves. More specifically, descriptive characteristics do not relate to the meanings or implications of the values in terms of whether a value is a ‘good’ value or a ‘bad’ value, too high or too low, or inside a range or outside a range.

In an example, a data point is communicated from an input device and has a value of 4.10000. It can easily be ascertained that the data point has five digits after the decimal point, and that the data point is expressed as a fixed-point number and not as a floating-point number; to phrase this another way, respective descriptive characteristics of ‘number format’ and ‘data format’ can be ascertained from the data point and its value. In another aspect, the data format descriptive characteristic may differentiate between the different ways of expressing numbers as data, such, for example, as binary, octal, decimal or hexadecimal numbers.

In another example, a data point from an input device has 12 addressable bits of data. The bit length of a data point can also be a descriptive characteristic, and when a data point is accessed, for example, by a supervisory computer, the bit length descriptive characteristic can be ascertained.

By testing or checking the descriptive characteristics of the data points, it is possible to identify anomalous descriptive characteristics which may indicate a threat to the security of the industrial control system or of the communications network, or even a breach or attempted breach thereof, and subsequently provide an alarm or other warning of a potential threat or breach or, for example, of the possibility of intruders attacking or taking control of one or more components or processes of the system or of the network.

Descriptive characteristics of data points can be tested using a rule or an algorithm or a heuristic, or checked against a normative descriptive characteristic, to determine whether any descriptive characteristic is anomalous. A normative descriptive characteristic can be one of an acceptable value for the respective descriptive characteristic, a range or set of values for the respective descriptive characteristic, and a value derived using a rule, algorithm or heuristic and deemed an appropriate value for the respective descriptive characteristic. If a descriptive characteristic fails a test or deviates from a normative descriptive characteristic, it can be determined, including based on a rule or an algorithm or a heuristic, to be anomalous. Alternatively it can be determined to be not anomalous if the degree of deviation from normative or the extent of test failure is below a given or derived threshold.

In embodiments, a normative descriptive characteristic can be pre-programmed into an input device such as a sensor in order to create a ‘security signature’ for the purpose of enhancing the security of the industrial control system. For example, a sensor can be pre-programmed to introduce a discretization artifact or a rounding artifact or any other descriptive characteristic into the data stream that is accessed by the industrial control system or by any of the security enhancement systems described herein; this unique descriptive characteristic acts as a security signature by virtue of being recognized as a pre-determined normative descriptive characteristic, where the absence of such a security signature could cause a determination of anomalousness.

A test can include using a rule, for example one stored in a machine-readable database accessible by the supervisory computer, or can include using an algorithm or heuristic that is part of a set of executable program instructions. A rule can also be derived or generated each time that a further determination is performed.

In the example above in which a data point from an input device has 12 addressable bits of data and the bit length of a data point is an ascertained descriptive characteristic, a test can be used to determine whether or not this descriptive characteristic, i.e., 12-bit bit length, is anomalous for the respective input device or its functional equivalent. Alternatively or additionally, the 12-bit bit length can be checked against a normative descriptive characteristic for this respective input device or its functional equivalent; for example, a machine-readable database accessible by the supervisory computer may include a normative descriptive characteristic for bit length of the respective input device or its functional equivalent. In the example, if the normative descriptive characteristic is a 12-bit bit length, then there is no deviation and the exemplary descriptive characteristic is not anomalous. If the normative descriptive characteristic is an 8-bit bit length, then in one aspect this deviation can be determined as being anomalous and an alarm or other communications function is performed, and in another aspect, further determination can be made as to whether this deviation or discrepancy (between 12-bit bit length and 8-bit bit length) is anomalous, i.e., whether an alarm or other communications functions is to be performed. The further determination of whether a deviation or discrepancy is anomalous can be made using at least one of a rule, for example one stored in a machine-readable database accessible by the supervisory computer, or can include using an algorithm or heuristic that are part of a set of executable program instructions. A rule can also be derived or generated each time that a further determination is performed.

When testing or checking whether descriptive characteristics are anomalous and a functional equivalent of the respective input device is used for the testing or checking rather than the respective input device itself, a functional equivalent is preferably selected based on the descriptive characteristics of the data points it generates or processes or sends being the same or similar to those generated or processed or sent by the respective input device. A functional equivalent can be an input device that is similar to the respective input device, or a set of similar input devices.

Descriptive characteristics of a data point can also include the precision of a data point. For example, a data point can be in a single-precision format (e.g., a 32-bit number) or a double-precision format (e.g., a 64-bit number).

Descriptive characteristics of a data point can also include data encoding characteristics. Data encoding characteristics for analog-to-digital signal conversion may include, for example, pulse code modulation and delta modulation. Alternatively, data encoding types for digital-to-digital signal mapping may include, for example, NRZ (non-return to zero)-level, NRZ-inverted, biphase-manchester encoding, differential-manchester, 4B/5B encoding, and 8B/6T encoding.

Descriptive characteristics of a data point can include rounding characteristics and/or rounding artifacts. In an example, a data point is accessed with a value of 5764 and a ‘rounding characteristic’ descriptive characteristic of ‘rounded to the nearest integer’ is ascertained. In another aspect, ‘rounding artifact’ descriptive characteristics of ‘even number’ and ‘not integrally divisible by 5’ are ascertained. Any such descriptive characteristics can be checked and/or tested. For example, a checking can include comparing the ascertained descriptive characteristic against a database of pre-determined normative descriptive characteristics, retrieved from a computer-readable medium, and thereby allow a determination as to whether being ‘not integrally divisible by 5’ is anomalous for the respective input device or its functional equivalent. Alternatively the normative ‘rounding artifact’ descriptive characteristic, rather than being pre-determined, can be generated or derived each time the checking or comparing step is carried out. In one aspect, the generating or deriving can include using or applying a rule. An example of a rule is that ‘each data point value in a sequential series of data points must be integrally divisible by the respective data point's ordinal position in the series.’ Such a rule can be stored, for example in a database on a computer-readable medium, which may or may not be the same computer-readable medium used to store databases of normative descriptive characteristics and/or program instructions for process steps including, but not exhaustively, process steps such as accessing data streams from input devices, ascertaining descriptive characteristics, and determining whether descriptive characteristics are anomalous, and any other process steps described in this disclosure or similar thereto in nature or function and useful for identifying anomalous descriptive characteristics in data communicated in an industrial control system and/or for performing a communications functions with respect thereto. In another aspect, the generating or deriving of the normative descriptive characteristic can be machine-learned or resultant from data mining or derived using an algorithm or a heuristic.

In embodiments, data can include streams of data that comprise sets of multiple data points. A set of multiple data points can comprise sequential data points within the data stream but in some embodiments the data points may be non-sequential. For example, data can include a set of multiple data points sampled sequentially or randomly or periodically from a data stream. In some aspects the sampling from the data stream can be at a predetermined frequency or periodicity or can be based on at least one of system status, network status, or computer status. In some aspects the sampling of the data stream may be linked to a characteristic of an earlier sampling or discretization of an analog signal that creates the data stream.

Pluralities of data points and their respective values can have descriptive characteristics. Descriptive characteristics of pluralities of data points can be in addition to or instead of the descriptive characteristics of the individual data points of the respective pluralities of data points. Descriptive characteristics of pluralities (or sets or series) of data points and their respective data values do not relate to the respective values themselves, i.e., the descriptive characteristics are not related to the meanings or implications of the values in terms of whether a value is a ‘good’ value or a ‘bad’ value, too high or too low, or inside a range or outside a range, but in some embodiments they can be related to, for example, distributions of values, patterns of values, frequency of value occurrence, or any other aspect of the statistics of values of multiple data points.

In an example, 50 sequential data points from a single input device are accessed and have identical values. Descriptive characteristics of individual data points as described elsewhere in this disclosure can also be ascertained. A number of additional descriptive characteristics of the set of sequential data points are ascertained, the additional descriptive characteristics pertaining to the plurality of data points and not to individual data points. The latter ascertained descriptive characteristics include: (1) distribution of values (‘y=a constant’ or ‘distribution is a flat line parallel to the x-axis’); (2) pattern of values (‘all values are the same’); (3) frequency of value occurrence (‘the single constant value occurs at 100% of data points’).

In another example, 500 non-sequential data points from a single input device are accessed and analyzed, and descriptive characteristics are ascertained, by a multi-processor computer executing program instructions that are stored in a non-transitory computer-readable medium, the program instructions including process steps comprising at least the accessing, analyzing and ascertaining steps as well as steps for determining whether any of the ascertained descriptive characteristics are anomalous and, if so, performing a communication function such as creating a visual or audible alarm on a human-machine interface, or communicating data or the fact of an alarm to either a supervisory control system or a plant operator, and/or recording the anomalous data and/or the fact of the alarm in a database. When the descriptive characteristics are ascertained for the 500 non-sequential data points, the descriptive characteristic ‘distribution of values’ is ascertained amongst them, and is ‘non-linear distribution with distortion at the extremes’. The ‘distribution of values’ descriptive characteristic is tested using an algorithm encoded in the program instructions and determined in the ‘determining’ step to fail the test because the algorithm tests for ‘linearity of distribution of values’ for the respective input device. The test failure is further determined to be anomalous, i.e., indicate an anomalous descriptive characteristic, and a visual alarm appears on a computer monitor manned by a plant operator, communicating indications of a potential security-related issue, along with at least one of the component system ID, component description, and physical location of the respective input device.

Like descriptive characteristics of individual data points, descriptive characteristics of pluralities or sets of data points can be tested using one or more of a rule or an algorithm or a heuristic, or checked against a normative descriptive characteristic, for determining whether any descriptive characteristic is anomalous. The testing and/or checking for the two types of descriptive characteristics (i.e., descriptive characteristics for single data points and descriptive characteristics for pluralities of data points) are the same, subsequent to the descriptive characteristics having been ascertained. All subsequent process steps including those related, for example, to determining whether descriptive characteristics are anomalous, or to further determining whether deviations from normative descriptive characteristics are anomalous, or to further determining whether test failures are anomalous, or to performing a communication function with respect to an anomaly as disclosed herein, are also the same for the two types of descriptive characteristics.

Analyzing descriptive characteristics of multiple data points can be useful for checking or ensuring that input devices such as sensors, RTUs, PLCs, etc., are behaving according to specifications and program instructions, are following rules, and are behaving as they always have. For example, by analyzing multiple data points it is possible to examine whether the numerical relationship between adjacent or non-adjacent values is within acceptable parameters or is anomalous. Descriptive characteristics of pluralities of data points can include ‘reporting thresholds’ of input devices. In an example, two sequential data points in a data stream from an input device are accessed, the data points having values of 881.1 and 881.2 respectively, and analyzed to ascertain the descriptive characteristic ‘reporting threshold’ (‘+0.1 increase in value’). The descriptive characteristic is checked against a database of normative descriptive characteristics and determined to be anomalous because the database includes a normative ‘reporting threshold’ descriptive characteristic of ‘report only with a minimum +0.5 increase in value’. In another example, the descriptive characteristic is determined to be anomalous when tested using a rule that the family of sensors functionally equivalent to the respective input device are programmed to report values only upon a change in value of at least 0.05% relative to the previous value.

In embodiments, temporal relationships between and among data points can be examined to determine whether they are within acceptable parameters or are anomalous. For example, the temporal spacing of data points can indicate the characteristics of the discretization or analog to digital sampling that created a data stream, can indicate whether for example a PLC is spending excessive time ‘thinking’ and thus delaying reports, and can indicate whether for example an input device is ‘blindly’ reporting periodically when it was originally programmed to report only upon change of value, or vice versa. Descriptive characteristics of pluralities of data points can include report timing, reporting frequency and reporting periodicity. In an example, the ‘reporting periodicity’ descriptive characteristic of a set of data points accessed in a data stream from an input device is ascertained to be ‘with irregular temporal spacing’ and this descriptive characteristic is determined after both checking against a database of normative descriptive characteristics and testing using a heuristic to be anomalous because a normative descriptive characteristic for the respective input device includes ‘with regular temporal spacing’, and in addition a heuristic encoded in program instructions that contain the determining step test the data point for regular temporal spacing in determining whether the ‘reporting periodicity’ descriptive characteristic is anomalous, and in this case determine that it is indeed anomalous. In another example, a data stream is ascertained to have no periodicity and this is determined to be non-anomalous. In other examples, ‘reporting frequency’ descriptive characteristics of respective sets of sequential data points are ascertained to be, in one example, longer than a normative descriptive characteristic, and in another example shorter than a ‘reporting frequency’ calculated using a function of the PLC processor clock speed of the respective input device where the function is included in a rule for testing a reporting frequency’ descriptive characteristic thereof. In further examples, ‘report timing’ can be a descriptive characteristic wherein the consistency of adherence of an input device to a reporting schedule is tested or checked to determine whether the consistence of adherence is within normal operating parameters or anomalous. For example, an anomalously late (or early) data point in a data stream could indicate network delays or computational delays that may indicate a security threat.

Descriptive characteristics of pluralities of data points in a data stream from an input device can include discretization parameters and, as a corollary thereof, discretization artifacts. Discretization parameters can include static parameters of analog-to-digital converter specifications including for example accuracy, resolution, dynamic range, offset, gain, differential nonlinearity, and integral nonlinearity; frequency-domain dynamic parameters including for example signal-to-noise-and-distortion ratio, effective number of bits, spurious-free dynamic range, Total harmonic distortion, Intermodulation distortion, effective resolution bandwidth, full-power bandwidth, and full-linear bandwidth; and time-domain dynamic parameters including for example aperture delay, aperture jitter, transient response and overvoltage recovery. In some embodiments testing of ‘discretization parameters’ descriptive characteristics, and especially testing in a determining step in which it is determined whether a descriptive characteristic is anomalous, can include Fourier analysis to test dynamic parameters using, for example, the discrete Fourier transform or the fast Fourier transform or other mathematical models; histogram tests for differential nonlinearity and integral nonlinearity; sine wave curve fit for effective number of bits; and other tests as are known in the art for testing analog-to-digital conversion parameters and identifying artifacts therefrom.

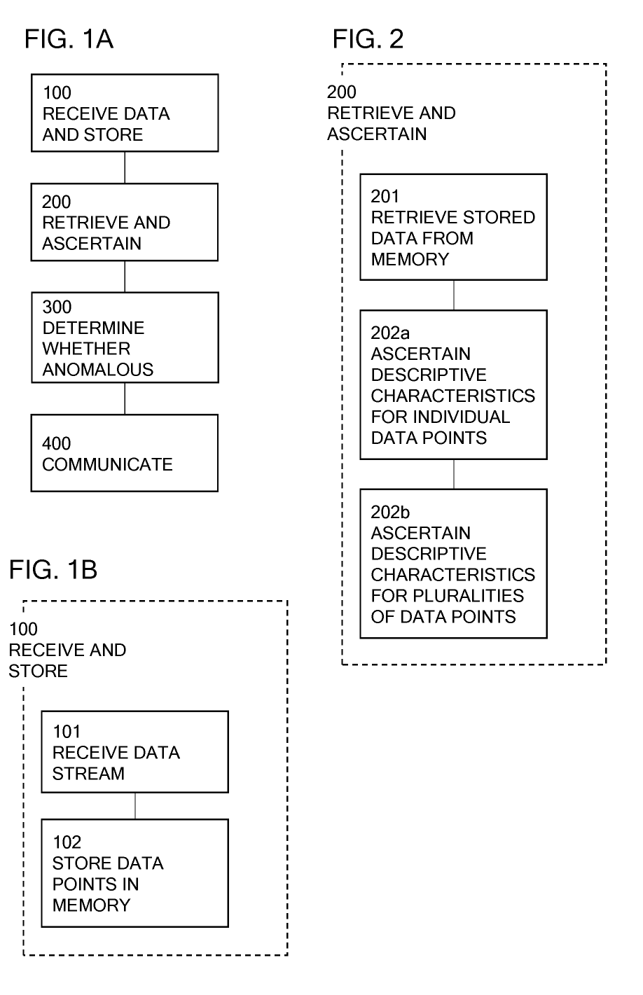

Referring now to FIG. 1A, the steps of a process for enhancing the security of an industrial control system according to an illustrative embodiment are shown therein. The process steps, each of which is described in greater detail below with reference to FIGS. 1B, 2, 3 and 4, respectively, include: process step 100 ‘receive data and store’ which includes accessing a data stream from one or more input devices through a communications network or I/O subsystem of a computer system; process step 200 ‘retrieve and ascertain’ which includes the ascertaining of descriptive characteristics of individual data point or of pluralities of data points; process step 300 ‘determine whether anomalous’ which includes applying a comparison with a database or application of a rule, algorithm or heuristic to determine whether any of the ascertained descriptive characteristics are anomalous; and process step 400 ‘communicate’ which includes performing a communications function in case one or more descriptive characteristics are found to be anomalous, the communications function being at least one of creating an alarm, communicating data or an alarm to at least one of a control system and an operator, and recording the data or the alarm in a database.

FIG. 1B provides further detail, according to an embodiment, of process step 100 ‘receive data and store’. Process step 100 can include a first substep 101, ‘receive data stream’ which includes accessing or receiving a data stream from an input device of an industrial control system through a communications network or the I/O subsystem of a computer system, and a second substep 102, in which some or all of the elements (data points) of the data stream are stored in computer memory. The computer memory can be volatile (as an illustrative example, one of the kinds of random-access memory commonly used in computer systems) or non-volatile (as non-limiting examples, flash memory or solid state memory or magnetic or optical storage).

FIG. 2 provides further detail, according to an embodiment, of process step 200 ‘retrieve and ascertain’. Process step 200 can include a first substep 201, in which program instructions are executed to retrieve stored data points from computer memory, and additional substeps 202a and 202b, in which one or more sets of program instructions can be executed to ‘ascertain descriptive characteristics for individual data points’ or ‘ascertain descriptive characteristics for pluralities of data points,’ respectively.

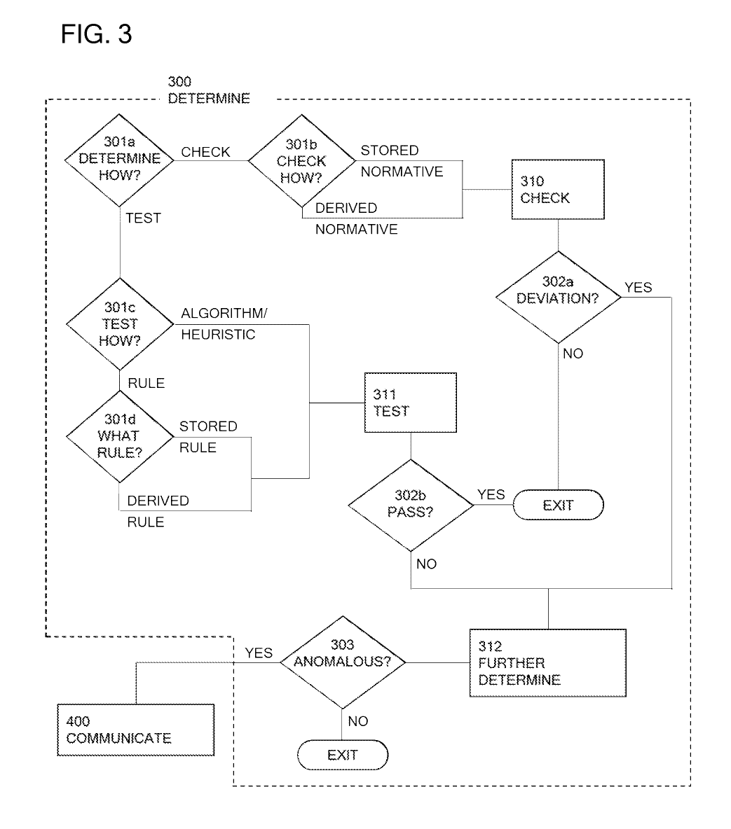

FIG. 3 provides further detail, according to an embodiment, of process step 300 ‘determining’. Process step 300 can include executing of program instructions to ‘decide’ (decision 301a) whether determining whether a descriptive characteristic is anomalous will be done by checking against a normative descriptive characteristic or by a test. For clarity, ‘decisions’ are shown in the various figures as separate and distinct from process steps and substeps only for the purpose of illustration in order to show that process flows have alternate ‘branches’ and in various embodiments the ‘decisions’ can be included in the respective process steps or substeps and can even be the primary aspects of respective process steps or substeps. The term ‘selected’ herein with respect to a decision shown in a process flow in the various figures can mean that the outcome is selected or determined through execution of a set of program instructions, whether actively or passively, before, during or after a respective process step or substep, or alternatively it can mean that any decision outcome can be pre-determined, for example by programming or system design. If ‘checking against a normative descriptive characteristic’ is selected, then the process can include decision 301b whether the checking will be against a normative descriptive characteristic that is stored, e.g., stored in a database in a non-transitory computer-readable medium, or against a normative descriptive characteristic that is specifically derived during execution of program instructions in order to carry out process step 300. (All ‘deriving’ and ‘generating’ described here is the result of executing a set of program instructions.) The normative descriptive characteristic can be derived or generated using a rule, an algorithm or a heuristic, wherein the rule can be stored, for example in a database, or derived or generated each time a normative descriptive characteristic is generated or derived. In any of these cases the ‘checking’ branch of the process includes according to an embodiment a first substep 310 in which a ‘checking’ or comparison is made between a descriptive characteristic (that was ascertained in process step 200) and a normative descriptive characteristic. Substep 310 ‘checking’ leads to decision 302a whether the checking or comparing to a normative descriptive characteristic yielded a determination that the descriptive characteristic deviated from the normative descriptive characteristic. If ‘no’ then process step 300 ends (‘exits’) and process step 400 is not performed with respect to the particular descriptive characteristic that is being ‘determined’. If ‘yes’ then either (a) according to a first aspect (as illustrated) process substep 312 is performed to ‘further determine’ whether the deviation is anomalous, leading to decision 303 whether the deviation is in fact anomalous, and if not then process step 300 ends (‘exits’) and process step 400 is not performed with respect to the particular descriptive characteristic that is being ‘determined’; or (b) according to a second aspect every deviation is considered anomalous and process substep 312 ‘further determine’ and decision 303 are skipped. In both the first aspect in the case that decision 303 yields ‘yes’ that the deviation is anomalous and in the second aspect in the case that every deviation from a normative descriptive characteristic is anomalous, then ‘determine’ process step 300 concludes, and process step ‘400’ ‘communicate’ is performed, i.e., ‘performing a communications function’, the communications function being at least one of creating an alarm, communicating data or an alarm to at least one of a control system and an operator, and recording the data or the alarm in a database. If from decision 301a the selected option is to ‘test’ the descriptive characteristic as opposed to ‘checking’ it against a normative descriptive characteristic as described above, then a further decision 301c is needed to determine whether the testing uses a rule, or an algorithm or a heuristic. In embodiments, algorithm and heuristics and functionally equivalent and are distinguished from rules in that rules can be either stored, for example in a non-transitory computer-readable medium, or generated or derived at least once each time a ‘determine’ process step 300 is performed with respect to a particular descriptive characteristic, while algorithms and heuristics according to embodiments are encoded in program instructions which, for example, can be encoded and stored in a non-transitory computer-readable medium and executed by a computer comprising at least one processor. If, with respect to decision 301c a rule is ‘selected’ to be used for testing the descriptive characteristic then decision 301d is needed to ‘select’ what kind of rule is to be applied in the test—a stored rule as described above, or a rule that is generated or derived as necessary. Whether using an algorithm, a heuristic, a stored rule or a derived rule, process substep 311 ‘test’ is carried out. This testing substep leads to decision 302b whether the descriptive characteristic passes the test. If the outcome is ‘yes’ then the process ends or ‘exits’ and process step 400 is not performed with respect to the particular descriptive characteristic that is being ‘determined’. If the outcome is ‘no’ indicating that the respective descriptive characteristic is at least potentially anomalous, then either (a) according to a first aspect (as illustrated) process substep 312 is performed to ‘further determine’ whether the test failure is anomalous, leading to decision 303 whether the test failure is in fact anomalous, and if not then process step 300 ends (‘exits’) and process step 400 is not performed with respect to the particular descriptive characteristic that is being ‘determined’; or (b) according to a second aspect every test failure is considered anomalous and process substep 312 ‘further determine’ and decision 303 are skipped. In both the first aspect in the case that decision 303 yields ‘yes’ that the test failure is anomalous and in the second aspect in the case that every deviation from a normative descriptive characteristic is anomalous, then ‘determine’ process step 300 concludes and process step ‘400’ ‘communicate’ is performed, i.e., ‘performing a communications function’, the communications function being at least one of creating an alarm, communicating data or an alarm to at least one of a control system and an operator, and recording the data or the alarm in a database.

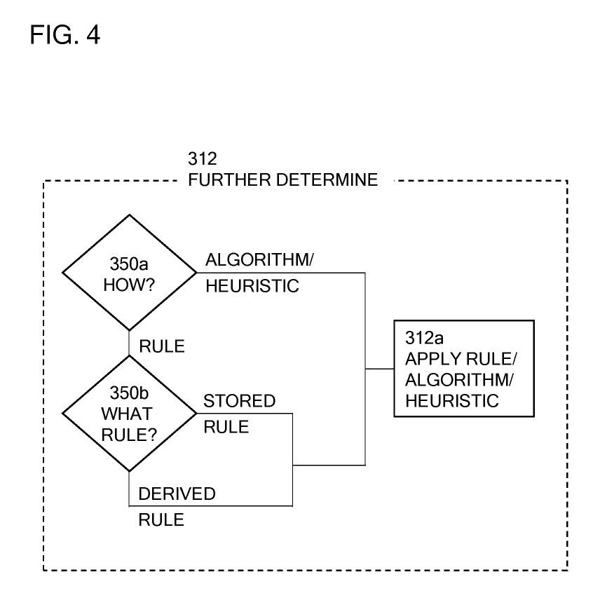

Further detail of process substep 312 ‘further determine’ according to an embodiment is illustrated in FIG. 4. The process substep begins with a decision 350a ‘how’ the further determination is to be carried out, wherein if by rule then by means of decision 350b one of ‘stored rule’ and ‘derived rule’ is selected, and otherwise by algorithm or heuristic but in all cases process sub-substep 312a ‘apply rule/algorithm/heuristic’ is carried out to make the ‘further determination’.

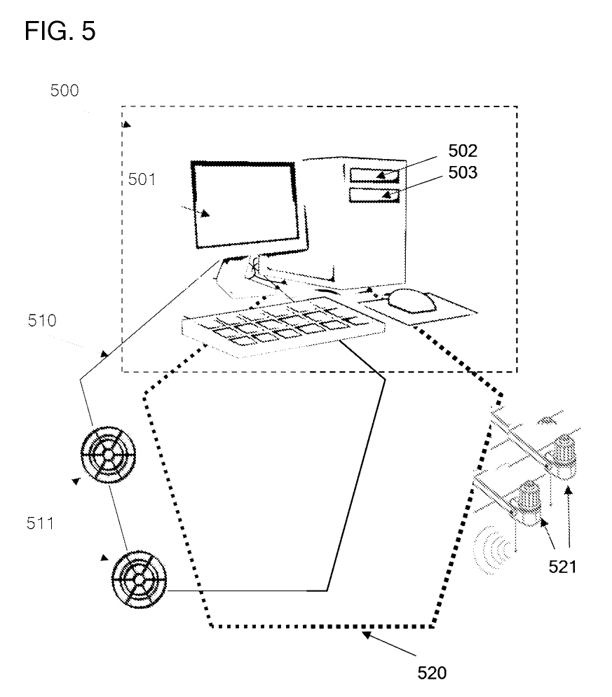

Referring now to FIG. 5, a computer system 500 according to an embodiment is shown. The computer system 500 includes at least one processor 502, and at least one non-transitory computer-readable medium 503. The computer system according to some embodiments includes a human-machine interface 501 which presents process data to a human operator, and allows the operator to issue commands. The computer system 500 can be in data communication with a plurality of computer networks such as wired communications network 510 and wireless communications network 520, which can include a plurality of input devices such as sensors 511 and wireless sensors 521, respectively. Input devices not shown can additionally or alternatively include other input devices such as PLCs and RTUs. The computer system 500 can have an I/O (input/output) subsystem, not shown, for managing and routing data transmissions to and from the computer system via communications systems 510 and 520. The computer system 500 and at least one of the communications networks 510 and 520 can be part of an industrial control system. Obviously an industrial control system can also include any of the computing and communications devices known in the art such as for example servers and proxy servers, gateways, access points, base stations, transponders, signal amplifiers, signal processors, etc.

Any or all of the process steps or substeps shown in FIGS. 1-4 or described herein for enhancing the security of an industrial control system can be performed by one or more processors of a computer system, for example processor 502 of computer system 500. Any process steps and substeps can be carried out as the result of executing program instructions by such a processor 502, where the program instructions are encoded or stored in a non-transitory computer-readable medium such as, for example, non-transitory computer-readable medium 503. The process steps and substeps can include performing of communications functions or accessing of data points in a data stream, any of which can be carried out by means of a communications network such as, for example, wired communications network 510, or wireless communications network 520, or an amalgam of such communications networks and can be routed through or managed by an I/O subsystem (not shown). Communications networks 510, 520 can include for example IP-based networks over various transports, can include shared or disparate networks and may utilize Web protocols for communication and display of data.

Various embodiments relate to systems and methods for resisting malicious code or actions from tampering with or otherwise exploiting an industrial control system (e.g. a Supervisory Control and Data Acquisition). Secure system elements may operate in a manner that assures the user that it has not been tampered with by malicious code of various types. At the same time, the various embodiments allow for the system to operate on existing hardware using existing firmware. Various embodiments provide a system which may have the ability to, for example, internally monitor activities of any function of the system; report on suspicious activity on the system by any function or program to a central server; apply a series of protective measures that reside internally on the system when suspicious activity is detected.

An attacker may take over an authorized observation or control station, for example, in the process control network, in the corporate control network, or the control system network. The attacker may then manipulate the parts of the technical unit covered by the authorized observation or control station they have taken over.

As the amount of data that may be analyzed or collected may be enormous, i.e. at least terabytes in size, some embodiments may include big data collecting and/or big data handling. The big data handling may be done online, offline or via sub-sampling.

Embodiments may relate to control networks in an industrial setting (including energy and water distribution or pipelines) or any other sector such as telecommunication networks.

Some embodiments may include further systems, such as existing off-the-shelf open operating systems and software stacks: (i) MAC-based Security; (ii) defense against malware and security among contexts through isolation and use of restricted inter-context communications (IPC) APIs; (iii) fast inter-process communication (IPC) mechanisms for high performance; and (iv) resistance to denial of service (DoS) attacks through monitoring, prioritization, and load balancing among contexts.

In some embodiments, a cryptographic signature can be employed in conjunction with any of the security enhancement methods and systems disclosed herein, to further enhance the security of an industrial control system using any of the cryptographic schemes known in the art for authentication of a digital signature. For example, one or more descriptive characteristics of a data stream accessed from an input device can form at least a part of a cryptographic signature.

It will be appreciated that the modules, processes, systems, and sections described above can be implemented in hardware, hardware programmed by software, software instruction stored on a non-transitory computer readable medium or a combination of the above. The processor can include, but is not limited to, a personal computer or workstation or other such computing system that includes a processor, microprocessor, microcontroller device, or is comprised of control logic including integrated circuits such as, for example, an application specific integrated circuit (ASIC). The instructions can be compiled from source code instructions provided in accordance with a programming language such as Java, C++, C#.net or the like. The instructions can also comprise code and data objects provided in accordance with, for example, the Visual Basic™ language, or another structured or object-oriented programming language. The sequence of programmed instructions and data associated therewith can be stored in a non-transitory computer-readable medium such as a computer memory or storage device which can be any suitable memory apparatus, such as, but not limited to read-only memory (ROM), programmable read-only memory (PROM), electrically erasable programmable read-only memory (EEPROM), random-access memory (RAM), flash memory, disk drive, etc.

Furthermore, the modules, processes, systems, and sections can be implemented as a single processor or as a distributed processor. Further, it should be appreciated that the steps discussed herein can be performed on a single or distributed processor (single and/or multi-core). Also, the processes, modules, and sub-modules described in the various figures of and for embodiments above can be distributed across multiple computers or systems or can be co-located in a single processor or system. Exemplary structural embodiment alternatives suitable for implementing the modules, sections, systems, means, or processes described herein are provided below, but not limited thereto. The modules, processors or systems described herein can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example. Moreover, embodiments of the disclosed method, system, and computer program product can be implemented in software executed on a programmed general purpose computer, a special purpose computer, a microprocessor, or the like.

Embodiments of the method and system (or their sub-components or modules), can be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, etc. In general, any process capable of implementing the functions or steps described herein can be used to implement embodiments of the method, system, or a computer program product (software program stored on a non-transitory computer readable medium).

Furthermore, embodiments of the disclosed method, system, and computer program product can be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of solar collection, thermal storage, electricity generation, and/or computer programming arts.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

Features of the disclosed embodiments can be combined, rearranged, omitted, etc., within the scope of the invention to produce additional embodiments. Furthermore, certain features can sometimes be used to advantage without a corresponding use of other features.

It is thus apparent that there is provided in accordance with the present disclosure, a method for detection of anomalous data characteristics for enhanced control system security. There are also provided in accordance with the present disclosure a number of devices including a non-transitory computer-readable medium containing program instructions, wherein execution of the program instructions by one or more processors of a computer system causes the one or more processors to carry out a method for detection of anomalous data characteristics for enhanced control system security. Many alternatives, modifications, and variations are enabled by the present disclosure. While specific embodiments have been shown and described in detail to illustrate the application of the principles of the present invention, it will be understood that the invention can be embodied otherwise without departing from such principles. Accordingly, Applicant intends to embrace all such alternatives, modifications, equivalents, and variations that are within the spirit and scope of the present disclosure.

1. A non-transitory computer-readable medium containing program instructions for enhancing the security of an industrial control system that includes at least one input device, wherein execution of the program instructions by one or more processors of a computer system causes the one or more processors to carry out the steps of:
receiving, via a communications network, a data stream comprising a plurality of data points from an input device, and storing at least some of the data points in computer memory;
retrieving stored data points from memory and ascertaining a plurality of descriptive characteristics thereof;
determining whether any of the plurality of descriptive characteristics are anomalous, using at least one of comparison with a stored normative descriptive characteristic in a database and application of an algorithm, heuristic or rule; and
when the existence of an anomalous descriptive characteristic has been determined, performing a communication function selected from the group consisting of creating an alarm, communicating data or an alarm to at least one of a control system and an operator, and recording the data or the alarm in a database.

2. The non-transitory computer-readable medium of claim 1, wherein the plurality of descriptive characteristics includes a descriptive characteristic of an individual data point, the descriptive characteristic being selected from the group consisting of data format, number format, data encoding characteristics, bit length, precision, rounding characteristics, rounding artifacts.

3. The non-transitory computer-readable medium of claim 1, wherein the plurality of descriptive characteristics includes a descriptive characteristic of a plurality of data points, the descriptive characteristic being selected from the group consisting of distributions of values, patterns of values, frequency of values, discretization parameters, discretization artifacts, report timing, reporting thresholds, reporting frequency and reporting periodicity.

4. The non-transitory computer-readable medium of claim 1, wherein the program instructions include at least one of a rule, an algorithm or a heuristic to be applied in carrying out the determining step.

5. The non-transitory computer-readable medium of claim 1, additionally containing at least one of a database comprising a stored normative descriptive characteristic and a stored rule for determining whether a descriptive characteristic is anomalous.

6. A method of enhancing the security of an industrial control system that includes at least one input device, comprising the steps of:
receiving, via a communications network or an I/O subsystem of a computer system, a data stream from an input device and storing all or part of the data stream in computer memory;
retrieving stored elements of the data stream from memory and executing a set of program instructions for ascertaining a plurality of descriptive characteristics thereof;
determining whether any of the plurality of descriptive characteristics are anomalous, using at least one of comparison with a stored normative descriptive characteristic in a database and application of an algorithm, heuristic or rule; and
when the existence of an anomalous descriptive characteristic has been determined, performing a communication function selected from the group consisting of creating an alarm, communicating data or an alarm to at least one of a control system and an operator, and recording the data or the alarm in a database.

7. The method of claim 6, wherein the plurality of descriptive characteristics includes a descriptive characteristic of an individual data point.

8. The method of claim 7, wherein a descriptive characteristic is selected from the group consisting of data format, number format, data encoding characteristics, bit length, precision, rounding characteristics and rounding artifacts.

9. The method of claim 6, wherein the plurality of descriptive characteristics includes a descriptive characteristic of a plurality of data points.

10. The method of claim 9, wherein a descriptive characteristic is selected from the group consisting of distributions of values, patterns of values, frequency of values, discretization parameters, discretization artifacts, report timing, reporting thresholds, reporting frequency and reporting periodicity.

11. The method of claim 9, wherein the plurality of data points comprises sequential points in the data stream.

12. The method of claim 6, wherein the determining comprises testing descriptive characteristics using at least one of a rule, algorithm or heuristic.

13. The method of claim 6, wherein the determining comprises comparing at least one of the descriptive characteristics to a normative descriptive characteristic or set of normative descriptive characteristics for the same input device or its functional equivalent, and further determining whether any deviation existing therebetween renders a respective descriptive characteristic anomalous.

14. The method of claim 13, wherein at least one of the normative descriptive characteristics is pre-determined and stored in a computer-readable medium.

15. The method of claim 14, wherein the at least one of the pre-determined and stored normative descriptive characteristics is a security signature pre-programmed into the input device.

16. The method of claim 13, wherein at least one of the normative descriptive characteristics is generated or derived by executing a set of program instructions each time the comparing step is carried out.

17. The method of claim 16, wherein the generating or deriving of at least one of the normative descriptive characteristics is by using or applying a rule that is at least one of: stored in a computer-readable medium, and generated or derived by executing a set of program instructions each time the at least one of the normative descriptive characteristics is generated or derived.

18. The method of claim 16, wherein the at least one of the normative descriptive characteristics is machine-learned or resultant from data mining or derived using an algorithm or a heuristic.

19. The method of claim 13, wherein the further determining of whether a deviation is anomalous is carried out using or applying a rule that is at least one of: stored in a computer-readable medium, and generated or derived by executing a set of program instructions each time the further determining step is carried out.

20. The method of claim 13, wherein the further determining of whether a deviation is anomalous is carried out using an algorithm or a heuristic.

21. The method of claim 6, wherein the plurality of descriptive characteristics includes a rounding artifact.

22. The method of claim 6, wherein the plurality of descriptive characteristics includes a distribution of values.
